(19) United States
(12) Patent Application Publication
(10) Pub. No.: US 2020/0193937 A1
(43) Pub. Date: Jun. 18, 2020

(54) AUTOMATIC LIGHTNESS CORRECTION METHOD APPLIED TO DISPLAY PANEL

(71) Applicant: Raydium Semiconductor Corporation, Hsinchu (TW)

(72) Inventors: Pine TSAI, New Taipei City (TW); YM CHANG, Taipei City (TW); Hank LIN, New Taipei City (TW)

(21) Appl. No.: 16/710,210

(22) Filed: Dec. 11, 2019

Related U.S. Application Data
(60) Provisional application No. 62/778,329, filed on Dec. 12, 2018.

(51) Int. Cl. G09G 5/10

(52) U.S. Cl. CPC G09G 5/10; G09G 2320/0673; G09G 2320/0276

(57) ABSTRACT

An automatic lightness correction method applied to a display panel is disclosed. The automatic display screen lightness compensation method includes steps of: (a) dividing a display area of the display panel into sub-areas; (b) obtaining gamma curve corresponding to each sub-area; (c) selecting a target gamma curve from the gamma curves; (d) adjusting the gamma curves corresponding to the sub-areas to approach the target gamma curve; and (e) using the target gamma curve as a gamma mapping table for the entire display area of the display panel.

### BACKGROUND OF THE INVENTION

### 1. Field of the Invention

The invention relates to a display; in particular, to an automatic lightness correction method applied to a display panel.

### 2. Description of the Prior Art

With the development of display technology and the needs of consumers, the size of display panels on the market has become increasingly larger, such as display screens of more than 60 inches.

However, due to physical limitations on the manufacturing process of the display panel, the larger the size of the display panel, the more likely the lightness of the display areas on the display panel is inconsistent, which is commonly referred to as the Mura phenomenon. When the Mura phenomenon of the display panel is too severe, the entire display screen may be uneven due to the difference in lightness, resulting in poor display panel yield.

A common improvement method at present is to divide the entire display area of the display panel into a plurality of sub-areas, and then manually perform a lightness correction process for each of the plurality of sub-areas.

For example, as shown in FIG. 1, the entire display area DA of the display panel can be divided into 12 sub-areas SA1˜SA12, and then the lightness correction process is manually performed for the 12 sub-areas SA1˜SA12 respectively. However, as the size of the display panel increases, the number of divided sub-areas also tends to increase, resulting in a very long time required for lightness correction of the entire display area, and since the Mura phenomenon of each display panel is not necessarily the same, each display panel has to manually performed a lightness correction process, which is quite time-consuming and labor intensive and extremely inefficient.

### SUMMARY OF THE INVENTION

Therefore, the invention provides an automatic lightness correction method to solve the above-mentioned problems occurred in the prior arts.

An embodiment of the invention is an automatic lightness correction method. In this embodiment, the automatic lightness correction method is applied to a display panel. The automatic lightness correction method includes the following steps of:

(a) dividing a display area of the display panel into a plurality of sub-areas;

(b) obtaining a plurality of gamma curves corresponding to the plurality of sub-areas respectively;

(c) selecting a target gamma curve from the plurality of gamma curves;

(d) adjusting the plurality of gamma curves corresponding to the plurality of sub-areas to approach the target gamma curve; and

(e) using the target gamma curve as a gamma mapping table for the entire display area of the display panel.

In an embodiment, the step (b) is to obtain the gamma curve corresponding to each sub-area through a reference gamma curve.

In an embodiment, the target gamma curve in the step (c) corresponds to a specific area of the plurality of sub-areas.

In an embodiment, between the step (a) and the step (b), the automatic lightness correction method further includes a step of: calculating an average lightness of the plurality of sub-areas respectively.

In an embodiment, the step (d) is to adjust gamma curves corresponding to sub-areas other than the specific sub-area of the plurality of sub-areas to approach the target gamma curve.

In an embodiment, the plurality of sub-areas at least includes a first sub-area and a second sub-area; the first sub-area corresponds to a first gamma curve and the second sub-area corresponds to a second gamma curve.

In an embodiment, if the target gamma curve is the first gamma curve, the automatic lightness correction method adjusts the second gamma curve to approach the first gamma curve.

In an embodiment, if the target gamma curve is the second gamma curve, the automatic lightness correction method adjusts the first gamma curve to approach the second gamma curve.

In an embodiment, the plurality of sub-areas further includes a third sub-area and the third sub-area corresponds to a third gamma curve.

In an embodiment, if the target gamma curve is the first gamma curve, the automatic lightness correction method adjusts the second gamma curve and the third gamma curve to approach the first gamma curve.

In an embodiment, if the target gamma curve is the second gamma curve, the automatic lightness correction method adjusts the first gamma curve and the third gamma curve to approach the second gamma curve.

In an embodiment, if the target gamma curve is the third gamma curve, the automatic lightness correction method adjusts the first gamma curve and the second gamma curve to approach the second gamma curve.

Compared to the prior arts, the automatic lightness correction method applied to the display panel of the invention can separately calculate the Mura value of each sub-area in the entire display area of the display panel, thereby automatically detecting the lightness difference between the sub-areas and correcting the gamma value of the entire display area accordingly, so that the lightness of the screen displayed in the entire display area is relatively uniform, thereby effectively improving the unevenness of the color displayed on the display panel, thereby improving the yield of the display panel and significantly saving time spent on conventional lightness correction process to increase efficiency.

The advantage and spirit of the invention may be understood by the following detailed descriptions together with the appended drawings.

### BRIEF DESCRIPTION OF THE APPENDED DRAWINGS

FIG. 1 illustrates a schematic diagram of the display area DA of the display panel is divided into 12 sub-areas SA1˜SA12 and the lightness correction is manually performed in the prior art.

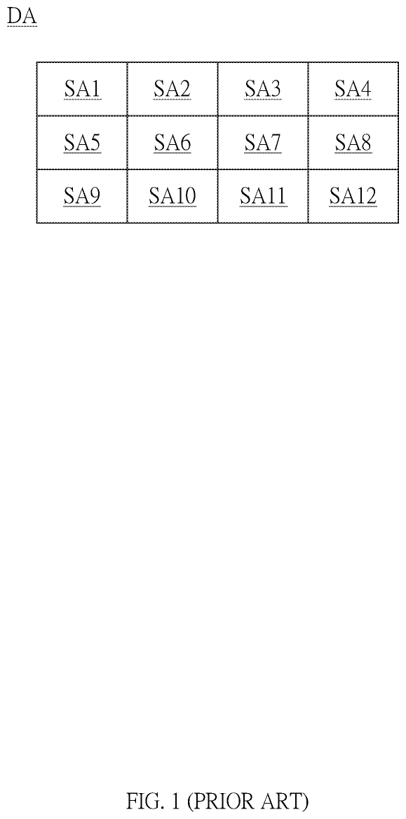

FIG. 2 illustrates a flowchart of the automatic lightness correction method applied to the display panel in a preferred embodiment of the invention.

FIG. 3 illustrates a flowchart of the automatic lightness correction method applied to the display area including 12 sub-areas in the display panel.

### DETAILED DESCRIPTION OF THE INVENTION

Reference will now be made in detail to the exemplary embodiments, the same or similar reference numbers or components used in the drawings and the embodiments are used to represent the same or similar parts.

An embodiment of the invention is an automatic lightness correction method applied to a display panel. In this embodiment, the display panel can be disposed on different products such as computer monitor, a TV, a display common on the market, and the types and structures of the display panel have no limitations.

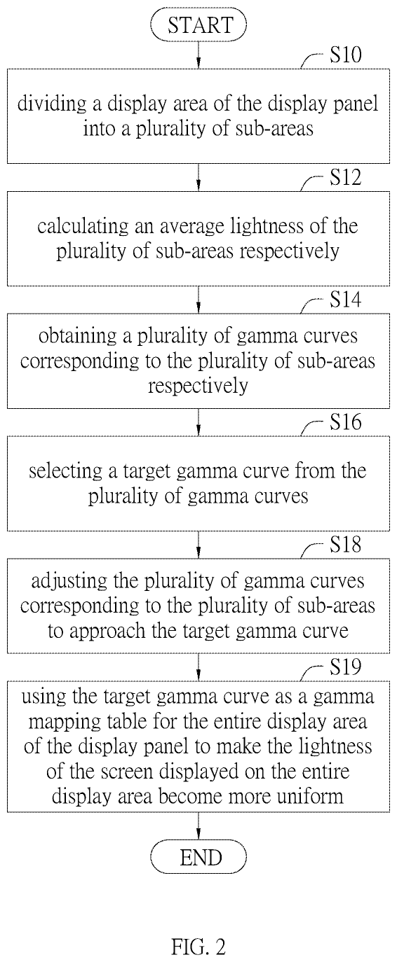

Please refer to FIG. 2. FIG. 2 illustrates a flowchart of the automatic lightness correction method applied to the display panel in this embodiment.

As shown in FIG. 2, the automatic lightness correction method can include the following steps of:

S10: dividing a display area of the display panel into a plurality of sub-areas;

S12: calculating an average lightness of the plurality of sub-areas respectively;

S14: obtaining a plurality of gamma curves corresponding to the plurality of sub-areas respectively;

S16: selecting a target gamma curve from the plurality of gamma curves;

S18: adjusting the plurality of gamma curves corresponding to the plurality of sub-areas to approach the target gamma curve; and

S19: using the target gamma curve as a gamma mapping table for the entire display area of the display panel to make the lightness of the screen displayed on the entire display area become more uniform.

In practical applications, the step S12 is used to respectively calculate the Mura value of each sub-area in the display area of the display panel, thereby automatically detecting the lightness difference between the sub-areas, but not limited to this; the step S14 is to obtain the gamma curve corresponding to each sub-area through a reference gamma curve, but not limited to this; the target gamma curve in the step S16 corresponds to a specific sub-area of the plurality of sub-areas, but not limited to this. The step S18 is to adjust gamma curves corresponding to sub-areas other than the specific sub-area of the plurality of sub-areas to approach the target gamma curve, so that the gamma values of the entire display area of the display panel can be automatically corrected.

For example, the plurality of sub-regions includes at least a first sub-region and a second sub-region, wherein the first sub-region corresponds to the first gamma curve and the second sub-region corresponds to the second gamma curve. If the target gamma curve is the first gamma curve, then the second gamma curve is adjusted to approach the first gamma curve; if the target gamma curve is the second gamma curve, then the first gamma curve is adjusted to approach the second gamma curve.

Similarly, the plurality of sub-regions can further include a third sub-region and the third sub-region corresponds to a third gamma curve. If the target gamma curve is the first gamma curve, then the second gamma curve and the third gamma curve are adjusted to approach the first gamma curve; if the target gamma curve is the second gamma curve, then the first gamma curve and the third gamma curve are adjusted to approach the second gamma curve; if the target gamma curve is the third gamma curve, then the first gamma curve and the second gamma curve are adjusted to approach the third gamma curve. The rest can be deduced by analogy and will not be described here.

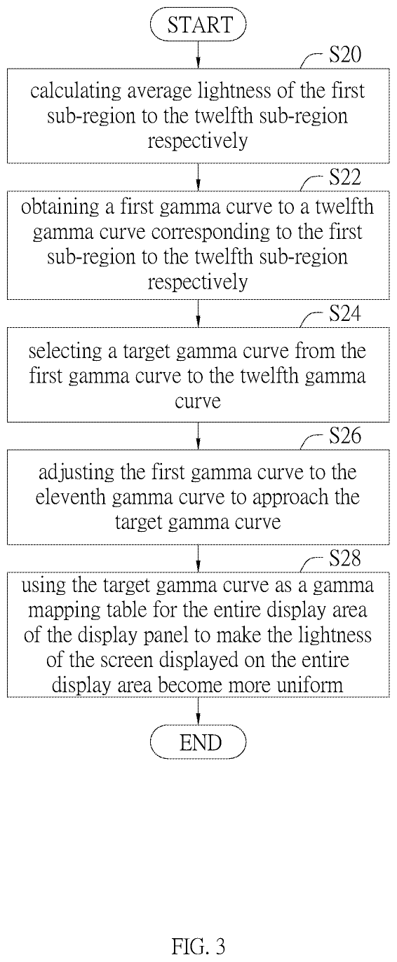

For example, if the display area of the display panel is divided into 12 sub-areas (i.e., a first sub-area to a twelfth sub-area), as shown in FIG. 3, when the automatic lightness correction method of the invention is applied to the display panel, it can include the following steps of:

S20: calculating average lightness of the first sub-region to the twelfth sub-region respectively;

S22: obtaining a first gamma curve to a twelfth gamma curve corresponding to the first sub-region to the twelfth sub-region respectively;

S24: selecting a target gamma curve from the first gamma curve to the twelfth gamma curve (assuming that the target gamma curve is the twelfth gamma curve);

S26: adjusting the first gamma curve to the eleventh gamma curve to approach the target gamma curve (i.e., the twelfth gamma curve);

S28: using the target gamma curve (i.e., the twelfth gamma curve) as a gamma mapping table for the entire display area of the display panel to make the lightness of the screen displayed on the entire display area become more uniform.

Compared to the prior arts, the automatic lightness correction method applied to the display panel of the invention can separately calculate the Mura value of each sub-area in the entire display area of the display panel, thereby automatically detecting the lightness difference between the sub-areas and correcting the gamma value of the entire display area accordingly, so that the lightness of the screen displayed in the entire display area is relatively uniform, thereby effectively improving the unevenness of the color displayed on the display panel, thereby improving the yield of the display panel and significantly saving time spent on conventional lightness correction process to increase efficiency.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An automatic lightness correction method, applied to a display panel, comprising steps of:
(a) dividing a display area of the display panel into a plurality of sub-areas;
(b) obtaining a plurality of gamma curves corresponding to the plurality of sub-areas respectively;
(c) selecting a target gamma curve from the plurality of gamma curves;
(d) adjusting the plurality of gamma curves corresponding to the plurality of sub-areas to approach the target gamma curve; and
(e) using the target gamma curve as a gamma mapping table for the entire display area of the display panel.

2. The automatic lightness correction method of claim 1, wherein the step (b) is to obtain the gamma curve corresponding to each sub-area through a reference gamma curve.

3. The automatic lightness correction method of claim 1, wherein the target gamma curve in the step (c) corresponds to a specific area of the plurality of sub-areas.

4. The automatic lightness correction method of claim 1, wherein between the step (a) and the step (b), the automatic lightness correction method further comprises a step of:
calculating an average lightness of the plurality of sub-areas respectively.

5. The automatic lightness correction method of claim 3, wherein the step (d) is to adjust gamma curves corresponding to sub-areas other than the specific sub-area of the plurality of sub-areas to approach the target gamma curve.

6. The automatic lightness correction method of claim 1, wherein the plurality of sub-areas at least comprises a first sub-area and a second sub-area; the first sub-area corresponds to a first gamma curve and the second sub-area corresponds to a second gamma curve.

7. The automatic lightness correction method of claim 6, wherein if the target gamma curve is the first gamma curve, the automatic lightness correction method adjusts the second gamma curve to approach the first gamma curve.

8. The automatic lightness correction method of claim 6, wherein if the target gamma curve is the second gamma curve, the automatic lightness correction method adjusts the first gamma curve to approach the second gamma curve.

9. The automatic lightness correction method of claim 6, wherein the plurality of sub-areas further comprises a third sub-area and the third sub-area corresponds to a third gamma curve.

10. The automatic lightness correction method of claim 9, wherein if the target gamma curve is the first gamma curve, the automatic lightness correction method adjusts the second gamma curve and the third gamma curve to approach the first gamma curve.

11. The automatic lightness correction method of claim 9, wherein if the target gamma curve is the second gamma curve, the automatic lightness correction method adjusts the first gamma curve and the third gamma curve to approach the second gamma curve.

12. The automatic lightness correction method of claim 9, wherein if the target gamma curve is the third gamma curve, the automatic lightness correction method adjusts the first gamma curve and the second gamma curve to approach the second gamma curve.
